(19) United States
(12) Patent Application Publication
(10) Pub. No.: US 2025/0004180 A1
(43) Pub. Date: Jan. 2, 2025

(54) MICROLENS STRUCTURE, MANUFACTURING METHOD THEREFOR, AND RELATED USE THEREOF

(71) Applicant: BOE Technology Group Co., Ltd., Beijing (CN)

(72) Inventors: Guangcai YUAN, Beijing (CN); Renquan GU, Beijing (CN); Qi YAO, Beijing (CN); Feng ZHANG, Beijing (CN); Xin GU, Beijing (CN); Kang GUO, Beijing (CN)

(21) Appl. No.: 18/708,769

(22) PCT Filed: Dec. 2, 2021
(86) PCT No.: PCT/CN2021/135157

§ 371 Date: May 9, 2024

(51) Int. Cl. G02B 3/00; G02B 30/29

(52) U.S. Cl. CPC G02B 3/005; G02B 30/29

(57) ABSTRACT

Provided in the embodiments of the present disclosure are a microlens structure, a manufacturing method therefor, and the related use thereof. The microlens structure comprises: a base substrate; a plurality of first microlenses, which are located on the base substrate and arranged at intervals; and a plurality of second microlenses, which are located on the base substrate and are located in gaps between the first microlenses, wherein edges of at least part of the second microlenses overlap edges of the corresponding first microlenses.

### CROSS REFERENCE TO RELATED APPLICATIONS

The present disclosure is a National Stage of International Application No. PCT/CN2021/135157, filed Dec. 2, 2021, which is hereby incorporated by reference in its entirety.

### TECHNICAL FIELD

The present disclosure relates to the field of a 3D display technology, in particular to a microlens structure, a manufacturing method therefor, and a related use thereof.

### BACKGROUND

Microlenses have the function of refracting light and focusing light, and can be applied to various optical components, such as the 3D light field display, augmented reality (AR), virtual reality (VR), sensors, optical functional films, etc.

### SUMMARY

Embodiments of the present disclosure provide a microlens structure, including: a base substrate; a plurality of first microlenses located on the base substrate, where the plurality of first microlenses are arranged at intervals; and a plurality of second microlenses located on the base substrate and respectively located at gaps between the plurality of first microlenses, respectively; where edges of at least part of the plurality of second microlenses overlap with edges of corresponding first microlenses.

Optionally, in the above-mentioned microlens structure provided by the embodiments of the present disclosure, edges of all the second microlenses overlap with edges of corresponding first microlenses.

Optionally, in the above-mentioned microlens structure provided by the embodiments of the present disclosure, an overlapping width of an edge of the second microlens with an edge of the first microlens is in a range of 0.5 μm to 2 μm.

Optionally, the above-mentioned microlens structure provided by the embodiments of the present disclosure further includes a plurality of transparent protection structures located between the plurality of first microlenses and the plurality of second microlenses and covering the plurality of first microlenses, where surface topographies of the plurality of transparent protection structures are the same as surface topographies of the plurality of second microlenses.

Optionally, in the above-mentioned microlens structure provided by the embodiments of the present disclosure, a material of the plurality of transparent protection structures include silicon nitride, silicon oxide or silicon oxynitride.

Optionally, in the above-mentioned microlens structure provided by the embodiments of the present disclosure, a material of the plurality of first microlenses is the same as a material of the plurality of second microlenses.

Optionally, in the above-mentioned microlens structure provided by the embodiments of the present disclosure, the material of the plurality of first microlenses and the material of the plurality of second microlenses both include a resin.

Optionally, in the above-mentioned microlens structure provided by the embodiments of the present disclosure, the resin includes at least one of a polyacrylic resin, a polyimide resin or a phenolic resin.

Optionally, in the above-mentioned microlens structure provided by the embodiments of the present disclosure, a difference between a caliber the first microlens and a caliber of the second microlens is in a range of 0 μm to 4 μm, and a difference between an arch height of the first microlens and an arch height of the second microlens is in a range of 0 μm to 3 μm.

Optionally, in the above-mentioned microlens structure provided by the embodiments of the present disclosure, the caliber of the first microlens and the caliber of the second microlens are both in a range of 10 μm to 300 μm, and the arch height of the first microlens and the arch height of the second microlens are both in a range of 5 μm to 30 μm.

Optionally, in the above-mentioned microlens structure provided by the embodiments of the present disclosure, surface precision of the plurality of first microlenses and surface precision of the plurality of second microlenses are both less than 10 nm, and roughness of the plurality of first microlenses and roughness of the plurality of second microlenses are both less than 1 nm.

Accordingly, the embodiments of the present disclosure further provide a display apparatus, including a display panel, and the microlens structure, as described in any one of aforementioned items provided by the embodiments of the present disclosure, located at a light emergent side of the display panel.

Optionally, in the above-mentioned display apparatus provided by the embodiments of the present disclosure, the base substrate of the microlens structure is a spacer layer, and the display apparatus further includes a planarization layer located at a side of the microlens structure away from the base substrate, and a refractive index of the planarization layer is smaller than a refractive index of the microlens structure.

Optionally, in the above-mentioned display apparatus provided by the embodiments of the present disclosure, an alignment deviation between the microlens structure and the display panel is less than or equal to 5 μm.

Optionally, in the above-mentioned display apparatus provided by the embodiments of the present disclosure, the display panel includes: a driving backplane; and a plurality of sub-pixels located between the driving backplane and the base substrate; where the plurality of sub-pixels are divided into multiple pixel islands, each of the pixel islands includes a plurality of sub-pixels, and sub-pixels in the same one pixel island display the same color; and along a direction perpendicular to an extension direction of the plurality of first microlenses, one pixel island corresponds to at least one of the plurality of first microlenses or at least one of the plurality of second microlenses, and a number of sub-pixels included in each pixel island is greater than or equal to a sum of a quantity of the first microlenses and the second microlenses corresponding to the pixel island.

Optionally, in the above-mentioned display apparatus provided by the embodiments of the present disclosure, the display panel is provided with a display region and a peripheral region disposed around the display region; where the peripheral region includes: a first sub-region and a second sub-region arranged along the direction perpendicular to the extension direction of the plurality of first microlenses, and a third sub-region and a fourth sub-region along the extension direction of the plurality of first microlenses; where along the direction perpendicular to the extension direction of the plurality of first microlenses, a sum of a quantity of the first microlenses and the second microlenses arranged in the first sub-region and a sum of a quantity of the first microlenses and the second microlenses arranged in the second sub-region each are greater than or equal to 5.

Accordingly, the embodiments of the present disclosure further provide a nanoimprint microlens template including the microlens structure as described in any one of the aforementioned items provided by the embodiments of the present disclosure.

Accordingly, the embodiments of the present disclosure further provide a method for manufacturing the microlens structure as described in any one of the aforementioned items provided by the embodiments of the present disclosure, including: manufacturing the plurality of first microlenses arranged at intervals on the base substrate; and manufacturing the plurality of second microlenses respectively located at the gaps between the plurality of first microlenses on the base substrate; where the edges of at least part of the plurality of second microlenses overlap with the edges of the corresponding first microlenses.

Optionally, in the above-mentioned method provided by the embodiments of the present disclosure, the manufacturing the plurality of first microlenses arranged at intervals on the base substrate specifically includes: forming a first photosensitive resin layer on the base substrate; exposing and developing the first photosensitive resin layer to form a plurality of first transition patterns that are set independently; and performing a first-time thermal reflow process on the plurality of first transition patterns to form the plurality of first microlenses.

Optionally, in the above-mentioned method provided by the embodiments of the present disclosure, the manufacturing plurality of second microlenses respectively located at the gaps between the plurality of first microlenses on the base substrate specifically includes: forming a second photosensitive resin layer on a side of the plurality of first microlenses away from the base substrate; exposing and developing the second photosensitive resin layer to form a plurality of second transition patterns respectively located between the plurality of first microlenses; where edges of at least part of the plurality of second transition patterns overlap with edges of corresponding first microlenses; and performing a second-time thermal reflow process on the plurality of second transition patterns to form the plurality of second microlenses; where the plurality of first microlenses and the plurality of second microlenses form the microlens structure.

### BRIEF DESCRIPTION OF FIGURES

In order to illustrate technical solutions of embodiments of the present application more clearly, drawings needing to be used in descriptions of the embodiments will be introduced below briefly. Apparently, the drawings described below are only some embodiments of the present application, and those ordinarily skilled in the art can further obtain other drawings according to these drawings without inventive efforts.

FIG. 1A is a schematic structural diagram of a microlens structure provided by an embodiment of the present disclosure.

FIG. 1B is a schematic structural diagram of another microlens structure provided by an embodiment of the present disclosure.

FIG. 2 is a schematic diagram of a comparison of transmittance of a non-photosensitive resin with transmittance of a photosensitive resin provided by an embodiment of the present disclosure.

FIG. 3A is a top view schematic diagram of first microlenses in FIG. 1A.

FIG. 3B is a top view schematic diagram of second microlenses in FIG. 1A.

FIG. 3C is another top view schematic diagram of first microlenses in FIG. 1A.

FIG. 3D is another top view schematic diagram of second microlenses in FIG. 1A.

FIG. 4 is a schematic flowchart of a method for manufacturing a microlens structure provided by an embodiment of the present disclosure.

FIG. 5 is a schematic flowchart of a method for manufacturing first microlenses in a microlens structure provided by an embodiment of the present disclosure.

FIG. 6 is a schematic flowchart of a method for manufacturing second microlenses in a microlens structure provided by an embodiment of the present disclosure.

FIG. 7A-FIG. 7H are schematic structural diagrams of the microlens structure shown in FIG. 1A after each manufacturing step provided by an embodiment of the present disclosure.

FIG. 8A-FIG. 8D are schematic structural diagrams of the microlens structure shown in FIG. 1B after each manufacturing step provided by an embodiment of the present disclosure.

FIG. 9 is a schematic structural diagram of a display apparatus provided by an embodiment of the present disclosure.

FIG. 10 is a schematic structural diagram of another display apparatus provided by an embodiment of the present disclosure.

FIG. 11 is a top view schematic diagram of the display apparatus shown in FIG. 9 and FIG. 10.

FIG. 12 is a schematic diagram of a specific structure of the display apparatus shown in FIG. 9.

FIG. 13 is a schematic diagram of a specific structure of the display apparatus shown in FIG. 10.

FIG. 14 is a stereoscopic schematic diagram of a microlens structure and pixel islands in FIG. 11.

FIG. 15 is a top view schematic diagram of a display apparatus.

### DETAILED DESCRIPTION

In order to make the purpose, technical solutions and advantages of the embodiments of the present disclosure clearer, the technical solutions of the embodiments of the present disclosure will be clearly and completely described below in conjunction with drawings of the embodiments of the present disclosure. Apparently, the described embodiments are some embodiments but not all embodiments of the present disclosure. Moreover, the embodiments in the present disclosure and features in the embodiments may be mutually combined without conflicts. Based on the described embodiments of the present disclosure, all other embodiments obtained by those ordinarily skilled in the art without creative work fall within the protection scope of the present disclosure.

Unless otherwise defined, technical or scientific terms used in the present disclosure shall have the ordinary meanings as understood by those with ordinary skills in the art to which the present disclosure belongs. Words “first”, “second” and similar words used in the present disclosure do not indicate any order, quantity or importance, but are only used to distinguish different assemblies. Word “comprise” or “include” or other similar words mean that the element or item appearing before the word encompasses the element or item listed after the word and its equivalents, but does not exclude other elements or items. Word “connection” or “connected” and similar words may include an electrical connection, direct or indirect, instead of being limited to a physical or mechanical connection.

It should be noted that the dimensions and shapes of the figures in the drawings do not reflect the real scale, and are only intended to illustrate the present disclosure. In addition, the same or similar reference numerals refer to the same or similar elements or elements having the same or similar functions throughout.

With the continuous development of display technology, the market and users have higher and higher requirements for the look and feel of display technology, and 3D display technology has gradually entered people's field of vision. At present, the implementation methods of 3D display technology include glasses type, light-shielding type, light refraction type, etc., and 3D display with the light refraction type can not only realize the naked eye 3D display, but also avoid the loss of brightness of the display device, so the light refraction type 3D display is an important research direction for the development of 3D display technology.

In related art, setting the microlens module on the light emergent side of the display device can realize the 3D light field display effect. In the light field display technology, at present, the microlens module is manufactured by the following manufacturing methods. One method is to use a one-time photolithography thermal reflow method to prepare the microlens module, but it is difficult to achieve the effect of tight connecting the microlenses with the one-time photolithography thermal reflow, so it is necessary to introduce a light-shielding layer to prevent the light emitted by the display device from being directly emitted from a gap(s) between the microlenses, thereby preventing light crosstalk. However, the introduction of the light-shielding layer requires the introduction of two masking processes (an alignment mark(s)+a light-shielding layer), which increases the complexity of the process and cost; at the same time, the alignment deviation between the light-shielding layer and the microlenses and the introduction of the light-shielding layer can reduce the light efficiency and viewing angle of the display device, and restrict the pixel resolution of the display device. Another method is to use a single-point diamond to manufacture a microlens template, and then use a nanoimprint technology to manufacture the microlens module. However, the use of the single-point diamond for the manufacture of the microlens template has problems such as high cost and difficulty in increasing the size.

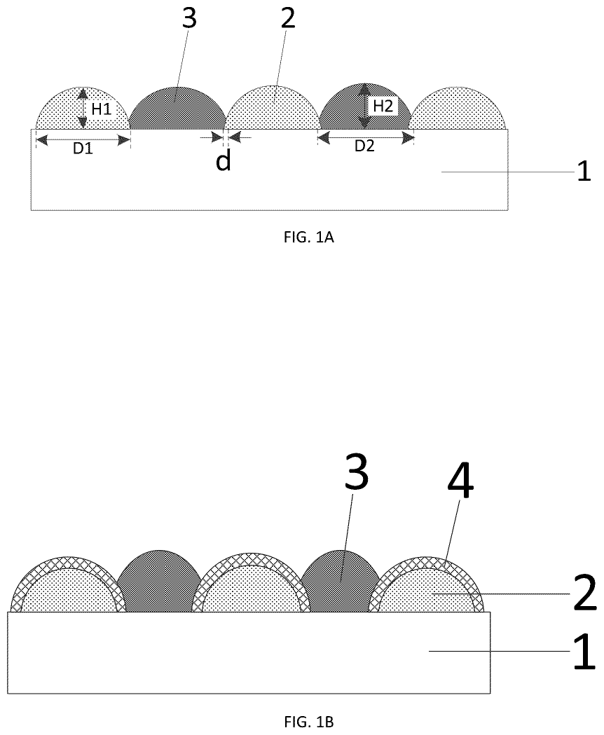

In view of this, in order to solve the problems in the related art that the one-time thermal reflow process cannot realize the tight connection of the microlenses and the manufacture of the microlens template using the single-point diamond has high cost and is difficult to increase in size, the embodiments of the present disclosure provide a microlens structure, as shown in FIG. 1A, including: a base substrate 1; a plurality of first microlenses 2 located on the base substrate 1; and the plurality of first microlenses 2 are arranged at intervals; and a plurality of second microlenses 3 located on the base substrate 1 and respectively located at gaps between the plurality of first microlenses 2, respectively; where edges of at least part of the plurality of second microlenses 3 overlap with edges of corresponding first microlenses 2.

In the above-mentioned microlens structure provided by the embodiments of the present disclosure, two kinds of microlenses (i.e., the first microlenses and the second microlenses) are arranged on the base substrate, so that the first microlenses and the second microlenses may be manufactured respectively by two-time thermal reflow processes. For example, the plurality of first microlenses arranged at intervals are firstly manufactured on the base substrate by one-time thermal reflow process, and then the plurality of second microlenses are manufactured to be respectively located at the gaps between the first microlenses on the base substrate by another-time thermal reflow process, and the edges of the second microlenses manufactured by the second-time thermal reflow process overlap with the edges of the first microlenses manufactured by the first-time thermal reflow process, that is, the microlens structure in which at least part of the second microlenses is in tight connection with the first microlenses is manufactured using a staggered filling method. In this way, when the microlens structure provided by the embodiments of the present disclosure is applied to the light emergent side of the display device to realize 3D light field display, it is not necessary to manufacture the light-shielding layer located at gaps between the microlenses to prevent light crosstalk. Therefore, the microlens structure provided by the embodiments of the present disclosure may omit the process of the alignment mark layer and the light-shielding layer, thereby reducing the complexity of the process and lowering the cost, and the omission of the light-shielding layer can improve the light efficiency and viewing angle of the display device, and can improve the pixel resolution of the display device.

It should be noted that the tight connection between the second microlenses and the first microlenses means that there are no gaps between the second microlenses and the first microlenses in at least one direction parallel to a horizontal plane where the first microlenses and the second microlenses are arranged.

It should be noted that, in the embodiments of the present disclosure, the material for manufacturing the microlens structure may be the resin. Specifically, the material of the microlens structure may be the photosensitive resin or non-photosensitive resin.

The photosensitive resin is defined as a cross-linked product of photosensitive resin monomers.

The photosensitive resin monomers can be understood as: the photosensitive group is attached to the resin monomer, or the photosensitive resin monomers are mixed with a photosensitive agent. Here the photosensitive agent may include photosensitive groups. It should be noted that under light irradiation conditions (such as ultraviolet light irradiation), the photosensitive resin monomers or the prepolymer of the photosensitive resin (i.e., the product of the photosensitive resin monomer after the prepolymerization) will produce a chemical reaction, and increase its solubility in the developer (such as an alkaline solution), so it is easy to be washed off, and thus can be patterned by direct photolithography.

The non-photosensitive resin monomers can be understood as: no photosensitive group is attached to the resin monomer, or the photosensitive resin monomers are not mixed with a photosensitive agent. Here the photosensitive agent may include photosensitive groups. Non-photosensitive resin monomers or the prepolymer of non-photosensitive resin monomers cannot be patterned by direct photolithography. The non-photosensitive resin may be a cross-linked resin formed by thermal initiation of non-photosensitive resin monomers.

For example, when the material for manufacturing the microlens structure is the photosensitive resin, the process may be mainly divided into three steps: 1, exposing the photosensitive resin layer (the film layer with the prepolymer of photosensitive resin) under the cover of the mask, and the exposed pattern may be, but is not limited to, a rectangle(s); 2, developing the exposed photosensitive resin layer to form a photosensitive resin pattern; and 3, placing the structure formed with the photosensitive resin pattern on a heating platform to form the microlens structure through the thermal reflow process.

Another example, when the material for manufacturing the microlens structure is the non-photosensitive resin: 1, forming a whole layer of photoresist on a side of the non-photosensitive resin layer (the film layer with the prepolymer of the non-photosensitive resin) away from the base substrate, the photoresist is exposed under the cover of the mask, and the expose pattern may be, but is not limited to, a rectangle(s); 2, developing the exposed photoresist to form a photoresist pattern; 3, etching the non-photosensitive resin layer by using the photoresist pattern as a mask to form a microlens pattern; and 4, placing the structure formed with the microlens pattern on a heating platform to form the microlens structure through the thermal reflow process.

In specific implementation, in the above-mentioned microlens structure provided by the embodiments of the present disclosure, as shown in FIG. 1A, edges of all the second microlenses 3 overlap with edges of corresponding first microlenses 2, so that all the second microlenses 3 are in tight connection with the corresponding first microlenses 2. When the microlens structure provided by the embodiments of the present disclosure is applied to the light emergent side of the display device to realize 3D light field display, the light crosstalk between the first microlens and the second microlens that are adjacent to each other may be obviously or even eliminated, greatly improving the light extraction efficiency of the microlens structure, and significantly improving the display effect.

In specific implementation, due to manufacturing process deviations and in order to achieve tight connection between the first microlenses and the second microlenses, in the above-mentioned microlens structure provided by the embodiments of the present disclosure, as shown in FIG. 1A, an overlapping width d of an edge of the second microlens 3 with an edge of the first microlens 2 may be in the range of 0.1 μm-2 μm. Preferably, the overlapping width d of the edge of the second microlens 3 with the edge of the first microlens 2 may be in the range of 0.5 μm-2 μm to ensure the effect of tight connection.

In some embodiments, since the first microlenses 2 and the second microlenses 3 are not formed through one process, there may be an obvious boundary at an overlapping position between the edge of the second microlens 3 and the first microlens 2. For example, when a section is made at the overlapping position of the edge of the second microlens 3 and the first microlens 2, the boundary outline between the edge of the second microlens 3 and the first microlens 2 can be seen.

Preferably, since the second microlenses are formed by the second-time thermal reflow process after the first microlenses are manufactured, in order to prevent the second-time thermal reflow process from melting the manufactured first microlenses, the above-mentioned microlens structure provided by the embodiments of present disclosure, as shown in FIG. 1B, further includes a plurality of transparent protection structures 4 located between the first microlenses 2 and the second microlenses 3 and covering the first microlenses 2. The surface topographies of the protection structures 4 is the same as the surface topographies of of the first microlenses 2. In this way, the plurality of transparent protection structures 4 are manufactured on the first microlenses 2 to cover the first microlenses 2 before the second microlenses 3 are formed, so as to protect the structure of the first microlenses 2 from being melted by the second-time thermal reflow process.

It should be noted that the same surface topography means substantially the same, not necessarily exactly the same.

It should be noted that the transparent protection structures 4 may only cover the surfaces of the first microlenses 2 to protect the topographies of the first microlenses 2. Optionally, the protection structures 4 may also cover at least part of the base substrate between the first microlenses 2. For example, the protection structures 4 completely covers the base substrate between the first microlenses 2, and the protection structures 4 may be made as a continuous and complete film structure, so that the protection structures 4 can be prepared through one process, e.g., deposition or sputtering) without the use of a mask, which simplifies the manufacture process.

In specific implementation, in the above-mentioned microlens structure provided by the embodiments of the present disclosure, as shown in FIG. 1B, the transparent protection structures 4 may be made of an inorganic material, and the inorganic material may include, but is not limited to, silicon nitride, silicon oxide, or silicon nitride.

In specific implementation, in the above-mentioned microlens structure provided by the embodiments of the present disclosure, as shown in FIG. 1A and FIG. 1B, a refractive index of the first microlenses 2 and a refractive index of the second microlenses 3 can both range from 1.5-1.8. Preferably, in order to ensure the consistency of the light-emitting effect, the first microlenses 2 and the second microlenses 3 have the same refractive index.

In specific implementation, in the microlens structure provided by the embodiments of the present disclosure, as shown in FIG. 1A and FIG. 1B, the material of the first microlenses 2 and the material of the second microlenses 3 may be the same. Of course, the material of the first microlenses 2 and the material of the second microlenses 3 may also be different, and the materials are selected according to actual needs.

In specific implementation, in order to reduce the influence of the protection structures 4 on the light emitted by the first microlenses 2, the refractive index of the protection structure 4 may be selected within the range of 1.5-1.8. Preferably, a refractive index of the protection structures 4 is the same or similarly to the refractive index of the first microlenses 2. The thickness of the protection structures 4 may be in the range of 10 nm-100 nm, which can not only have a better protective effect on the first microlenses 2, but also avoid the influence of the protection structure 4 with the excessive thickness on the light emitted by the first microlenses 2.

In specific implementation, in the microlens structure provided by the embodiments of the present disclosure, as shown in FIG. 1A and FIG. 1B, the material of the first microlenses 2 and the material of the second microlenses 3 both include the resin. For example, the material of the first microlenses 2 and the material of the second microlenses 3 both include photosensitive resin, or the material of the first microlenses 2 and the material of the second microlenses 3 both include the non-photosensitive resin. Taking the photosensitive resin to manufacture the first microlenses 2 and the second microlenses 3 as an example, a first photosensitive resin layer is coated on the base substrate, the first photosensitive resin layer is exposed and developed to form a first photosensitive resin pattern, then the first photosensitive resin pattern is subjected to the first-time thermal reflow process, the first photosensitive resin is heated to be cross-linked during the first-time thermal reflow process, and the cross-linked product is the first microlenses. Then a second photosensitive resin layer is coated on a side of the first microlenses away from the base substrate, the second photosensitive resin layer is exposed and developed to form a second photosensitive resin pattern, then the second photosensitive resin pattern is subjected to the second-time thermal reflow process, the second photosensitive resin is heated to be cross-linked during the second-time thermal reflow process, and the cross-linked product is the second microlenses.

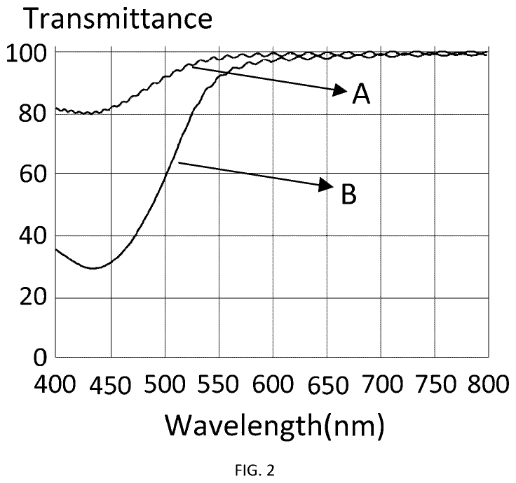

When the material of the first microlenses and the material of the second microlenses both include the non-photosensitive resin, the material of the first microlenses and the material of the second microlenses provided by the embodiments of the present disclosure do not have the photosensitive groups, and the transmittance is relatively high. As shown in FIG. 2, the comparison of transmittance of the non-photosensitive resin with transmittance of the photosensitive resin is shown in FIG. 2, the curve A is the transmittance of the non-photosensitive resin in the visible light wavelength band, and the curve B is the transmittance of the photosensitive resin in the visible light wavelength band. It can be seen that, in the wavelength band of 400 nm-550 nm, the transmittance of the non-photosensitive resin is significantly greater than the transmittance of the photosensitive resin, and especially in the blue light region, the transmittance of the non-photosensitive resin is higher. Therefore, in the above-mentioned microlens structure provided by the embodiments of the present disclosure, by using the non-photosensitive resin to form the microlens structure, the transmittance of the microlens can be greatly improved, and the problem of yellowing of the microlens can be avoided.

In specific implementation, in the microlens structure provided by the embodiments of the present disclosure, as shown in FIG. 2, in the wavelength band of 400 nm-600 nm, the transmittance (A) of the non-photosensitive resin is greater than or equal to 50%. Specifically, in the wavelength band of 400 nm-600 nm, the transmittance (A) of the non-photosensitive resin is greater than or equal to 75%. When the microlens structure manufactured by the non-photosensitive resin is used in 3D light field display, the white balance of the overall display device can be optimized. More specifically, in the visible light wavelength band (400 nm-780 nm), the transmittance (A) of the non-photosensitive resin is greater than 75%. By using the non-photosensitive resin with high transmittance, when the microlens structure provided by the embodiments of the present disclosure is applied to 3D light field display, the microlens manufactured by the non-photosensitive resin with high transmittance cannot affect the light-emitting chromaticity coordinates of the display device, and can reduce the yellowing of the microlens structure, thereby optimizing the white balance of the overall display device. In addition, when using the non-photosensitive resin to form the microlenses through the thermal reflow process, the heating temperature can be lower than 150° C. When the microlens structure is used in conjunction with the display panel (such as the OLED display panel, QLED display panel), the high heating temperature may affect the light-emitting efficiency and reliability of the display device in the display panel, therefore the use of the non-photosensitive resin to manufacture the microlens structure may improve the display effect and reliability of the display panel.

Specifically, the photosensitive resin or non-photosensitive resin can be selected to manufacture the microlens structure according to needs.

In specific implementation, in the above-mentioned microlens structure provided by the embodiments of the present disclosure, the photosensitive group may include, but not limited to, an azidoquinone group, a benzophenone group, a sulfonic acid group or an alkenyl ether group. The non-photosensitive resin provided by the embodiments of the present disclosure does not have a photosensitive group such as the azidoquinone group, the benzophenone group, the sulfonic acid group or the alkenyl ether group, and can form a reticulated cross-linked resin after thermal initiation. The reticulated cross-linked resin has a high transmittance, so the transmittance of the microlens structure is relatively high, and there will be no yellowing problem when the microlens structure is applied to 3D light field display.

It should be noted that both the non-photosensitive resin and the photosensitive resin may be at least one of the polyacrylic resin, polyimide resin or phenolic resin, and the difference between the non-photosensitive resin and the photosensitive resin is that the non-photosensitive resin does not have a photosensitive group(s), while the photosensitive resin has a photosensitive group(s). Specifically, the non-photosensitive resin and the photosensitive resin may be in a reticulated structure presenting a cross-linked state.

In the specific implementation, due to errors in the two-time thermal reflow processes, in the above-mentioned microlens structure provided by the embodiments of the present disclosure, as shown in FIG. 1A and FIG. 1B, a difference between a caliber D1 of a first microlens 2 and a caliber of a second microlens may be in the range of 0 μm to 4 μm, and a difference between an arch height H1 of the first microlens 2 and an arch height H2 of the second microlens 3 may be in the range of 0 am to 3 μm.

In specific implementation, when the microlens structure is combined with the display device to realize 3D light field display, in order to reduce the light crosstalk and improve the 3D display effect, in the above-mentioned microlens structure provided by the embodiments of the present disclosure, as shown in FIG. 1A and FIG. 1B, the caliber D1 of the first microlens 2 and the caliber D2 of the second microlens 3 may both be in the range of 10 am to 300 μm, and the arch height H1 of the first microlens 2 and the arch height H2 of the second microlens 3 may be in the range of 5 μm to 30 μm.

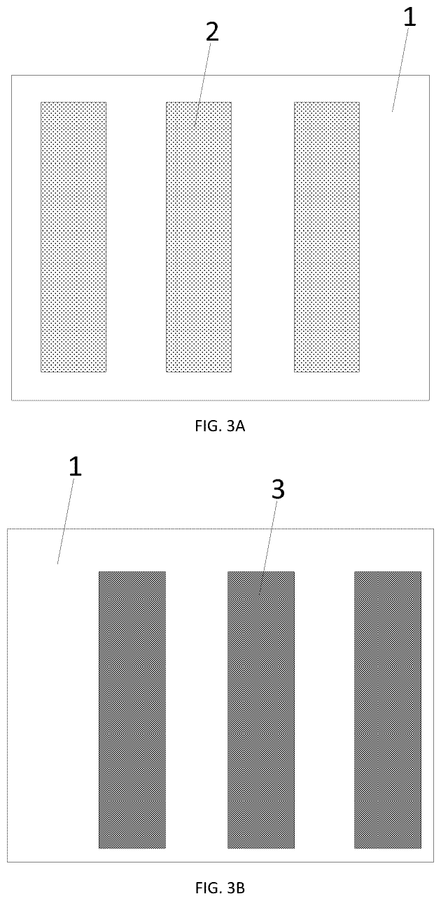

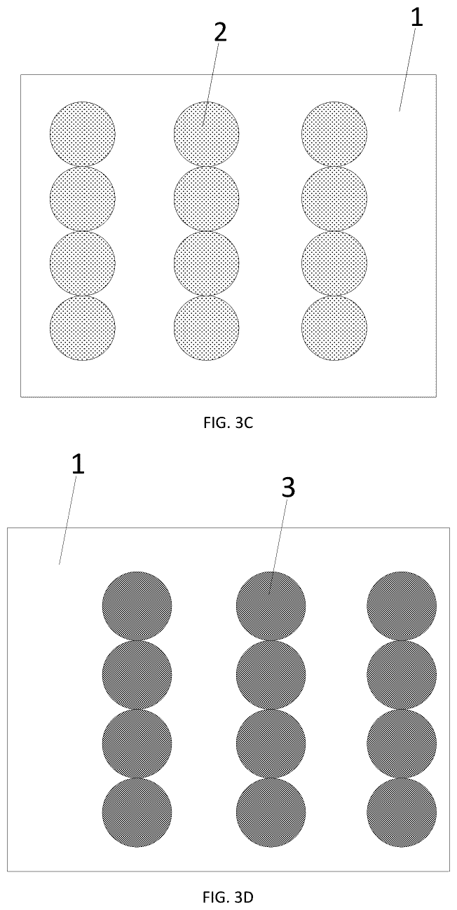

In specific implementation, the embodiments of the present disclosure do not specifically limit the shape and size of the first microlenses and the second microlenses. Exemplarily, the first microlenses and the second microlenses have a converging effect on light, as shown in FIG. 3A and FIG. 3B, FIG. 3A is a top view schematic diagram of the first microlenses 2 in FIG. 1A, and FIG. 3B is a top view schematic diagram of the second microlenses 3 in FIG. 1A. FIG. 3A and FIG. 3B take the first microlenses and the second microlenses are cylindrical lenses as an example. As shown in FIG. 3C and FIG. 3D, FIC. 3C is another top view schematic diagram of the first microlenses 2 in FIG. 1A, and FIG. 3D is another top view schematic diagram of the second microlenses 3 in FIG. 1A. FIG. 3C and FIG. 3D take the first microlenses and the second microlenses as circular lenses as an example. Certainly, the first microlenses and the second microlenses may also be in other shapes (for example, an ellipse or a rectangle with rounded corners in a top view).

In specific implementation, in the above-mentioned microlens structure provided by the embodiments of the present disclosure, as shown in FIG. 1A and FIG. 1B, the surface precision PV of the first microlenses 2 and the surface precision PV of the second microlenses 3 formed by using the thermal reflow processes are both less than or equal to 10 nm. Further, the surface precision PV of the first microlenses 2 and the surface precision PV of the second microlenses 3 formed by using the thermal reflow processes are both less than or equal to 5 nm. The roughness Ra of the first microlenses 2 and the roughness Ra of the second microlenses 3 formed by using the thermal reflow processes are both less than or equal to 1 nm. Further, the roughness Ra of the first microlenses 2 and the roughness Ra of the second microlenses 3 formed by using the thermal reflow processes are both less than or equal to 0.5 nm. Specifically, it can be measured by an atomic force microscope that the surface precision PV of the microlens(es) is in the range of 1 nm to 10 nm, and the roughness Ra of the microlens(es) is in the range of 0.1 nm to 1.0 nm, which is in line with the application of the microlens structure in light field display devices. In related art, in general, the microlenses formed by etching has a roughness Ra of greater than 10 nm and has a surface precision PV of greater than 10 nm; and the microlenses formed by nanoimprinting has a roughness Ra of greater than 1 nm and has a surface precision PV of greater than 10 nm. Therefore, the microlens structure with good performance can be formed by using the photosensitive resin provided by the embodiments of the present disclosure through the thermal reflow process.

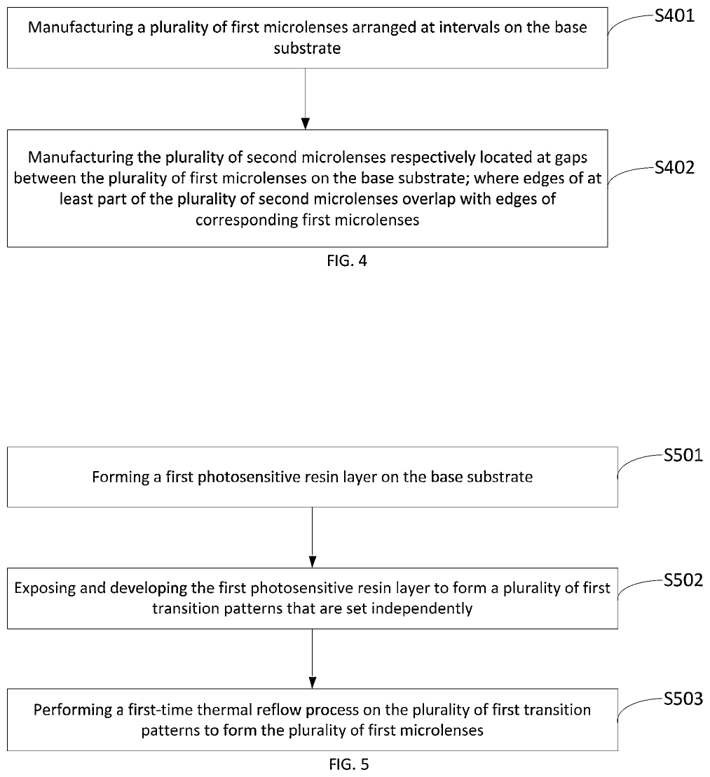

Based on the same inventive concept, the embodiments of the present disclosure also provide a method for manufacturing the aforementioned microlens structure, as shown in FIG. 4, including: S401, manufacturing the plurality of first microlenses arranged at intervals on the base substrate; S402, manufacturing the plurality of second microlenses respectively located at gaps between the plurality of first microlenses on the base substrate; where edges of at least part of the plurality of second microlenses overlap with edges of corresponding first microlenses.

In the method for manufacturing the above-mentioned microlens structure provided by the embodiments of the present disclosure, the first microlenses and the second microlenses are respectively manufactured by using two-time processes, for example, the plurality of first microlenses arranged at intervals are first manufactured on the substrate, and then the second microlenses are manufactured on the base substrate by using a staggered filling method, so as to realize the tight connection between the second microlenses and the first microlenses. In this way, when the microlens structure provided by the embodiments of the present disclosure is applied to the light emergent side of the display device to realize 3D light field display, it is not necessary to manufacture the light-shielding layer located in the gaps between the microlenses to prevent light crosstalk. Therefore, the microlens structure provided by the embodiments of the present disclosure may omit the process of the alignment mark layer and the light-shielding layer, thereby reducing the complexity of the process and lowering the cost, and the omission of the light-shielding layer can improve the light efficiency and viewing angle of the display device, and can improve the pixel resolution of the display device.

In specific implementation, in the above-mentioned manufacturing method provided by the embodiments of the present disclosure, taking the material of the first microlenses and the material of the second microlenses both include photosensitive resin as an example, as shown in FIG. 5, the manufacturing the plurality of first microlenses arranged at intervals on the base substrate may specifically include following steps.

S501, forming a first photosensitive resin layer on the base substrate.

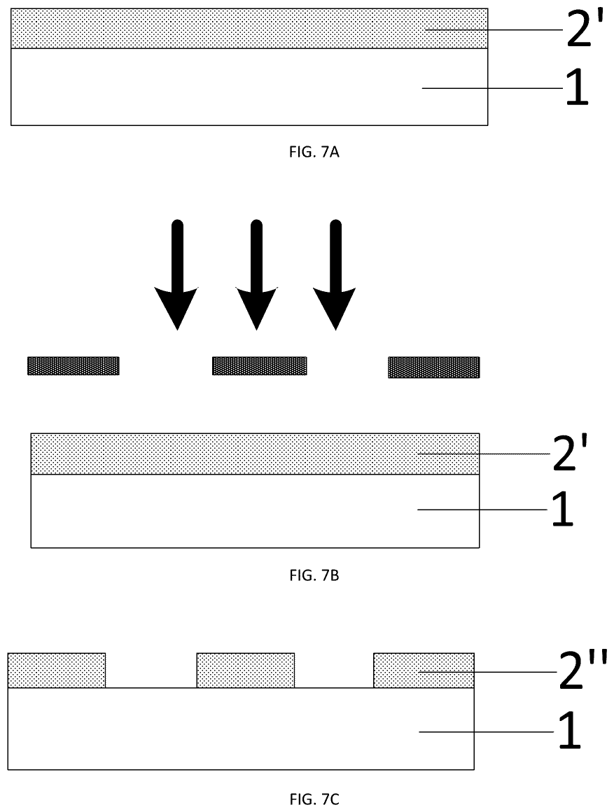

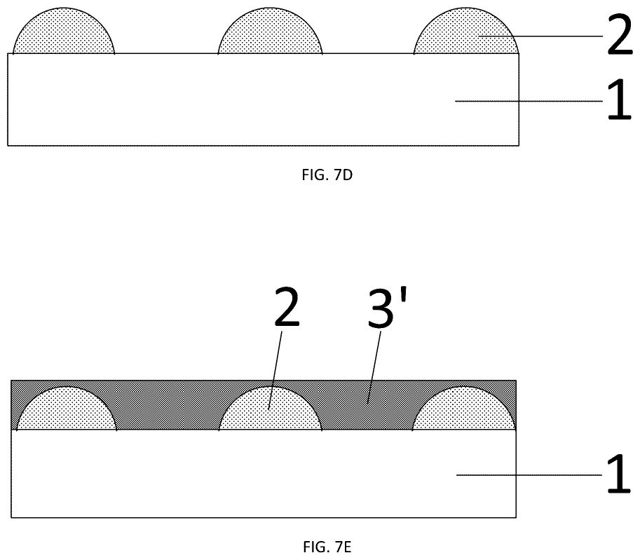

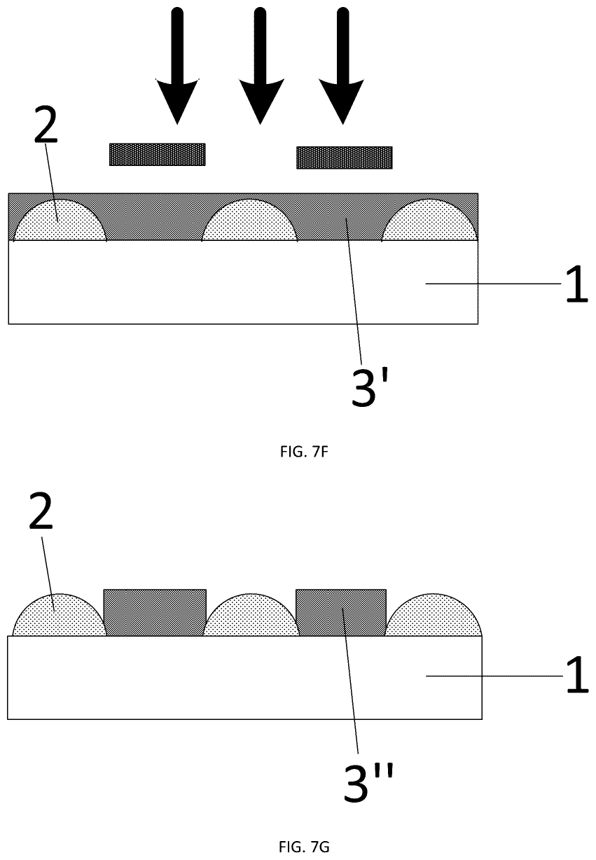

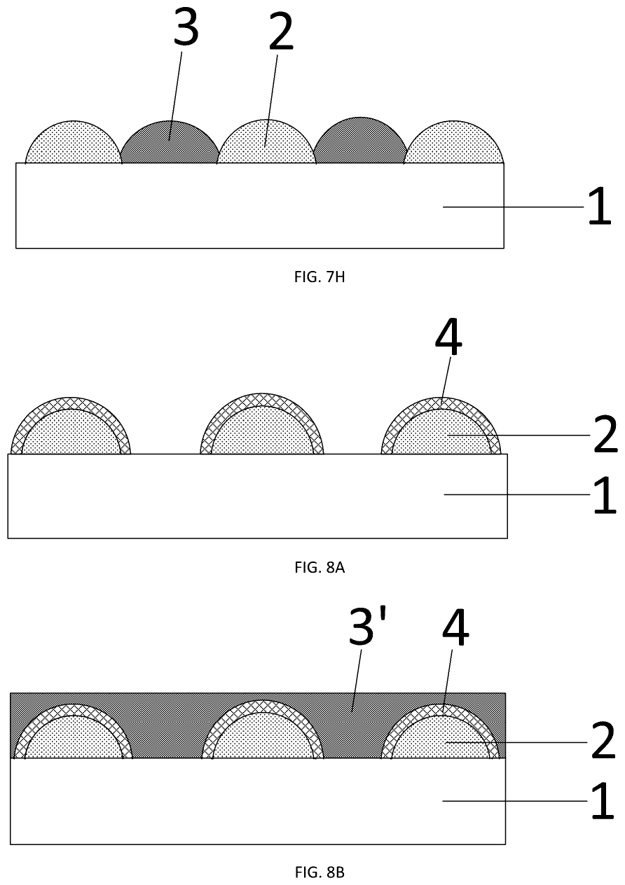

Specifically, as shown in FIG. 7A, the first photosensitive resin layer 2′ is formed on the base substrate 1.

Specifically, the first photosensitive resin layer in this step includes a prepolymer of photosensitive resin, and the prepolymer of the first photosensitive resin is a product of the first photosensitive resin monomers after the prepolymerization.

S502, exposing and developing the first photosensitive resin layer to form a plurality of first transition patterns that are set independently.

Specifically, as shown in FIG. 7B, the first photosensitive resin layer 2′ is exposed (shown by the arrow), and as shown in FIG. 7C, the first photosensitive resin layer 2′ is developed to form the plurality of first transition patterns 2″ set independently.

S503, performing a first-time thermal reflow process on the plurality of first transition patterns to form the plurality of first microlenses.

Specifically, as shown in FIG. 7D, the first-time thermal reflow process is performed on the first transition pattern 2″ shown in FIG. 7C to form the plurality of first microlenses 2.

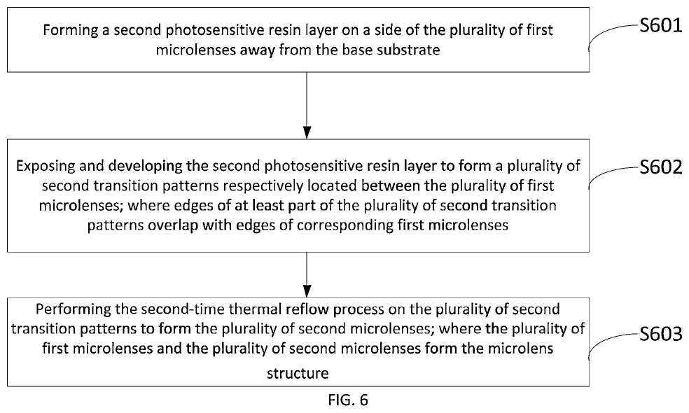

In specific implementation, in the above-mentioned manufacturing method provided by the embodiments of the present disclosure, as shown in FIG. 6, the manufacturing the plurality of second microlenses respectively located at the gaps between the plurality of first microlenses on the base substrate may include the following steps.

S601, forming a second photosensitive resin layer on a side of the plurality of first microlenses away from the base substrate.

Specifically, as shown in FIG. 7E, the second photosensitive resin layer 3′ is formed on the side of the first microlenses 2 away from the base substrate 1.

Specifically, the second photosensitive resin layer in this step includes a prepolymer of photosensitive resin, and the prepolymer of the second photosensitive resin is a product of the second photosensitive resin monomers after the prepolymerization.

It should be noted that the components included in the first photosensitive resin layer and the second photosensitive resin layer may be the same or different.

S602, exposing and developing the second photosensitive resin layer to form a plurality of second transition patterns respectively located between the plurality of first microlenses; where edges of at least part of the plurality of second transition patterns overlap with edges of corresponding first microlenses.

Specifically, as shown in FIG. 7F, the second photosensitive resin layer 3′ is exposed (shown by the arrow), and as shown in FIG. 7G, the second photosensitive resin layer 3′ is developed to form the plurality of second transition patterns 3″ respectively located between the first microlenses 2. The edges of at least part of the second transition patterns 3″ overlap with the edges of the corresponding first microlenses 2. Preferably, as shown in FIG. 7G, the edges of all the second transition patterns 3″ overlap with the edges of the corresponding first microlenses 2, so that all the second microlenses 3 manufactured subsequently are tightly connected with the corresponding first microlenses 2. In this way, when the microlens structure provided by the embodiments of the present disclosure is applied to the light emergent side of the display device to realize 3D light field display, it can be realized that there is no light crosstalk at all between the first microlens and the second microlens that are adjacent to each other, which greatly improves the light extraction efficiency of the microlens structure and significantly improves the display effect.

S603, performing the second-time thermal reflow process on the plurality of second transition patterns to form the plurality of second microlenses; where the plurality of first microlenses and the plurality of second microlenses form the microlens structure.

Specifically, as shown in FIG. 7H, the second-time thermal reflow process is performed on the second transition pattern 3″ shown in FIG. 7G to form the plurality of second microlenses 3.

In summary, the microlens structure shown in FIG. 1A provided by the embodiments of the present disclosure can be manufactured through FIGS. 7A to 7H.

The method for manufacturing the microlens structure shown in FIG. 1B is described below.

(1) The steps for manufacturing the first microlenses 2 refer to the above-mentioned FIGS. 7A to 7D, which will not be repeated herein.

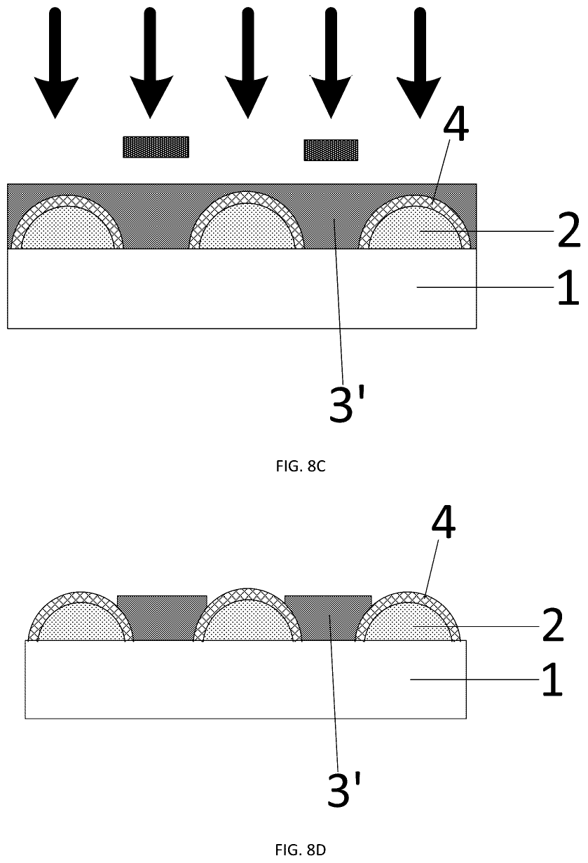

(2) One inorganic material film layer, such as silicon nitride, silicon oxide or silicon oxynitride, is deposited on a side of the first microlenses 2 facing away from the base substrate 1 in FIG. 7D, and the inorganic material film layer is patterned to form transparent protection structures 4 covering on the first microlenses 2, as shown in FIG. 8A.

(3) Specifically, as shown in FIG. 8B, a second photosensitive resin layer 3′ is coated on a side of the transparent protection structures 4 facing away from the base substrate 1.

(4) As shown in FIG. 8C, the second photosensitive resin layer 3′ is exposed (indicated by the arrow), and as shown in FIG. 8D, the second photosensitive resin layer 3′ is developed to form a plurality of second transition patterns 3″ respectively located between the transparent protection structures 4; where, edges of at least part of the second transition patterns 3″ overlap with edges of the corresponding transparent protection structures 4.

(5) As shown in FIG. 2, the second-time thermal reflow process is performed on the second transition pattern 3″ shown in FIG. 8D to form the plurality of second microlenses 3.

In summary, the microlens structure shown in FIG. 1B provided by the embodiments of the present disclosure may be manufactured through FIGS. 7A-7D, FIGS. 8A-8D, and FIG. 1B.

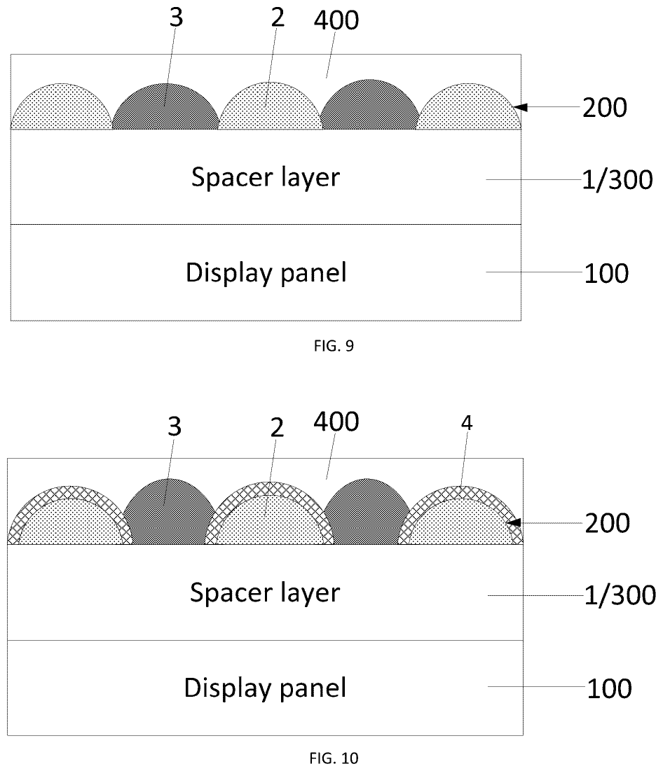

Based on the same inventive concept, the embodiments of the present disclosure also provide a display apparatus, as shown in FIG. 9 and FIG. 10, including: a display panel 100, and the above-mentioned microlens structure 200 as provided by the embodiments of the present disclosure located at the light emergent side of the display panel 100.

Specifically, the display panel 100 may be an organic light-emitting diode (OLED) display panel. By applying the microlens structure on the light emergent side of the display panel 100 and refracting the light emitted by the display panel 100 through the microlens structure 200, people can see objects with different depths of field, which is the feeling of people seeing the real world, that is, realizing the 3D light field display effect.

In specific implementation, in the above-mentioned display apparatus provided by the embodiments of the present disclosure, as shown in FIG. 9 and FIG. 10, the base substrate 1 of the microlens structure may be a spacer layer 300, the display apparatus further includes a planarization layer 400 located at a side of the microlens structure facing away from the base substrate 1, and a refractive index of the planarization layer 400 is smaller than the refractive index of the microlens structure 200. Specifically, the microlens structure 200 with a high refractive index and the planarization layer 400 with a low refractive index form a convex lens structure, which can increases the light extraction effect of the microlens structure 200. Specifically, the material of the planarization layer 400 may be the resin.

Specifically, the first microlenses 2 and the second microlenses 3 are cylindrical lenses.

Specifically, when the microlens structure is applied to the 3D light field display, the refractive index of the microlens structure is designed to be greater than or equal to the refractive index of the spacer layer between the microlens structure and the light-emitting device in the display panel, which can ensure that the light emitted by the light-emitting device is emitted effectively and improves the light-emitting efficiency. Specifically, the refractive indexes of the first microlenses 2 and the second microlenses may be designed to be larger than the refractive index of the spacer layer, which is beneficial to reduce the thickness of the spacer layer. Specifically, the refractive index of the microlens manufactured by the non-photosensitive resin is greater than the refractive index of the microlens manufactured by the photosensitive resin, which can be further beneficial to reduce the thickness of the spacer layer.

Specifically, the material of the spacer layer 300 may be at least one of an organic transparent material or an inorganic transparent material, for example, including glass.

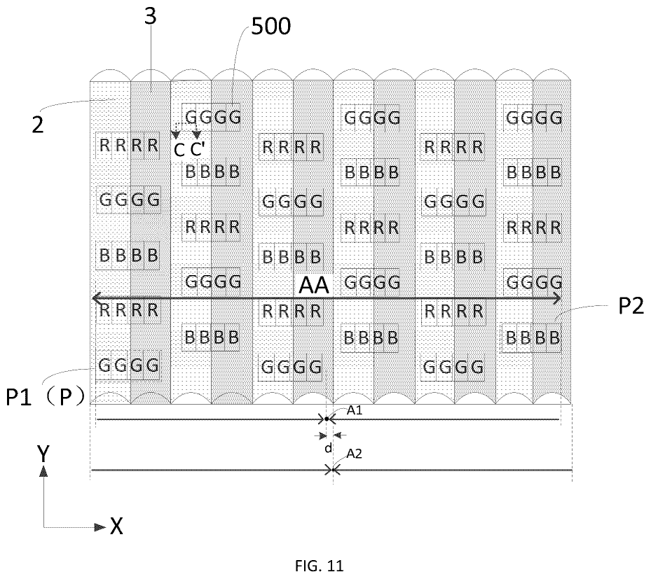

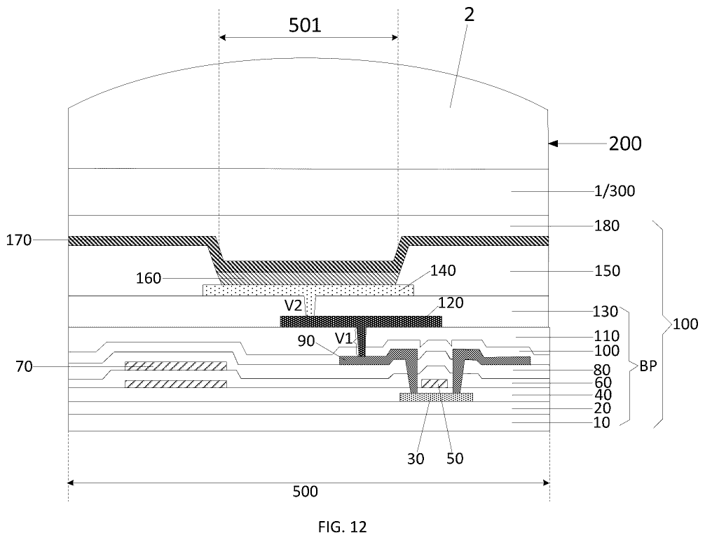

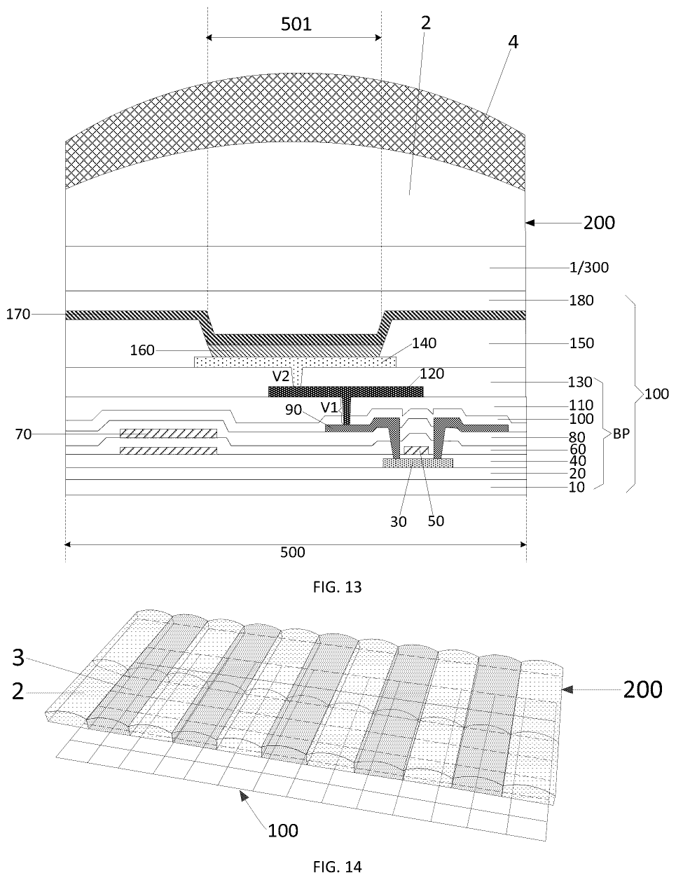

In specific implementation, in the above-mentioned display device provided by the embodiments of the present disclosure, as shown in FIGS. 11 to 14, FIG. 11 is a top view schematic diagram of the display apparatus, FIG. 12 and FIG. 13 are two cross-sectional schematic diagrams along CC′ direction, and FIG. 14 is a stereoscopic schematic diagram of the microlens structure 200 and the display panel 100 in FIG. 12 and FIG. 13. The display panel 100 include a driving backplane BP, and a plurality of sub-pixels 500 located between the driving backplane BP and the base substrate 1. FIG. 12 and FIG. 13 illustrate only one sub-pixel 500; each sub-pixel 500 includes a light-emitting region 501 of the sub-pixel, and the light-emitting region 501 is located inside the sub-pixel 500. As shown in FIG. 11, the plurality of sub-pixels 500 included in the display panel 100 may be divided into multiple pixel islands P (e.g., a pixel island P1 and a pixel island P2 schematically shown in FIG. 11). One pixel island P1 may include m sub-pixels 500, and the sub-pixels 500 in the same pixel island P1 display the same color. For example, the sub-pixels 500 include red sub-pixels (R), green sub-pixels (G) and blue sub-pixels (B). The sub-pixels included in the same one pixel island P1 are all red sub-pixels (R), or the sub-pixels included in the same one pixel island P1 are all green sub-pixels (G), or the sub-pixels included in the same one pixel island P1 are all blue sub-pixels (B). Here, along a direction (i.e. the direction X) perpendicular to an extension direction of the first microlens 2, one pixel island P may correspond to n microlenses (which may include at least one kind of the first microlenses and the second microlenses), m is greater than or equal to 2, and m is greater than or equal to n (e.g., n=1). Of course, the values of m and n can be set according to actual needs. It should be noted that, for pixel islands on the same one display panel, the number of pixel islands at different positions may be different for the requirements of 3D display, and the numbers n of microlenses corresponding to different pixel islands may also be different. However, for one pixel island, m is greater than or equal to n. It should be noted that one pixel island P may correspond to n microlenses, which can be understood as an orthographic projection of each of the n microlenses on the display panel 100 at least partially overlaps with the light-emitting region 501 of at least one sub-pixel 500 in the pixel island P, and orthographic projections of the two most marginal lenses (if n=1, the microlens itself) of the n microlenses on the display panel 100 are at least partially overlap with the light-emitting regions 501 of the most marginal sub-pixels 500 in the pixel island, respectively.

Specifically, by setting a corresponding relationship between the microlens structure and the pixel island(s), the light emitted by each sub-pixel in the pixel island(s) is refracted by the microlens structure to disperse to different pixel regions, so that the human eyes can watch different images, thereby realizing the 3D display effect.

As shown in FIG. 12 and FIG. 13, the driving backplane BP includes a buffer layer 20, an active layer 30, a first gate insulating layer 40, a first gate layer 50, and a second gate insulating layer 60, a second gate layer 70, an interlayer insulating layer 80, a first source-drain metal layer 90, a passivation layer 100, a first planarization layer 110, a second source-drain metal layer 120, and a second planarization layer 130 sequentially stacked on a substrate 10. Each sub-pixel includes an anode 140, a light-emitting layer 160, and a cathode 170 disposed on the second planarization layer 130, and the display panel 100 further includes a pixel defining layer 150 for defining the sub-pixels and an encapsulation layer 180 disposed between the cathode 170 and the spacer layer 300. The first source-drain metal layer 90 and the second source-drain metal layer 120 are electrically connected through a first via hole V1 penetrating the first planarization layer 110 and the passivation layer 100, and the anode 140 is electrically connected with the second source-drain metal layer 120 through a second via hole V2 penetrating the second planarization layer 130.

When the thermal reflow method is used to manufacture the microlens on the display panel, the alignment deviation between the microlens structure and the display panel may be less than or equal to 5 μm. In related art, for example, when nanoimprinting is used to manufacture the microlens structure, due to process limitations, the alignment deviation between the microlens structure and the display panel is greater than or equal to 10 μm.

Further, when the microlens structure is manufactured on the display panel by using the thermal reflow method, the angular deviation between the microlens structure and the display panel is less than or equal to 0.2°. Therefore, when the microlens structure manufactured by the thermal reflow method is used for 3D display, it can reduce the interference of the alignment deviation on the display effect, and can achieve a better light-emitting effect.

During specific implementation, in the above-mentioned display apparatus provided by the embodiments of the present disclosure, as shown in FIG. 11, the display panel 100 has a display region AA, and edges of the region AA are defined by edges of the light-emitting region of the outermost sub-pixels. The alignment deviation between the microlens structure and the display panel can be defined in the following manner. As shown in FIG. 11, taking m=4 and n=1 as an example, along the direction (i.e., the direction X) perpendicular to the extension direction of the first microlens 2, a midpoint of a distance between the outermost edge of the light-emitting region 501 of the outermost sub-pixels 500 in the pixel island P1 at an edge of the region AA and the outermost edge of the light-emitting region 501 of the outermost sub-pixels 500 in the pixel island P2 at an opposite side edge of the region AA is the first midpoint A1. A midpoint of a distance between an edge, close to an edge of the region AA, of a first microlens 2 corresponding to the outermost sub-pixels 500 in P1 and an edge, close to an edge of the region AA, of a second microlens 3 corresponding to the outermost sub-pixels 500 in P2 is the second midpoint A2. A distance d between the first midpoint A1 and the second midpoint A2 along the direction perpendicular to the extension direction of the first microlens 2 is less than or equal to 5 μm. In this way, the angular deviation between the microlens structure and the pixel island P1 may be made less than or equal to 0.2°, which meets the requirements of 3D display. In actual verification, when the microlenses are manufactured using the thermal reflow method, the angular deviation between the microlens structure and the pixel island P1 may even be less than or equal to 0.008°. Therefore, the microlens structure manufactured on the light emergent side of the display panel 100 by using the thermal reflow process provided by the embodiments of the present disclosure can greatly improve the alignment accuracy between the microlens structure and the pixel island(s), reduce processing costs, and realize the in-plant processing mode in which the microlens structure is directly integrated with the display panel.

It can be understood that the above-mentioned specific embodiments provide a form of measurement of the alignment deviation between the microlens structure and the display panel. According to the differences in the forms of the display panel and the microlens structure and in the combination form of the display panel and the microlens structure, a corresponding measurement method can be given. Generally, the midpoint of the distance between the edges of the light-emitting regions corresponding to the sub-pixels closest to the edges of the region AA and the midpoint of the distance between the edges of the microlenses corresponding to the sub-pixels closest to the edges of the region AA may be measured. The alignment deviation is obtained by calculating a horizontal distance between the midpoints along the direction in which the microlenses are arranged (for example, in the above embodiments, the direction perpendicular to the extension direction of one microlens).

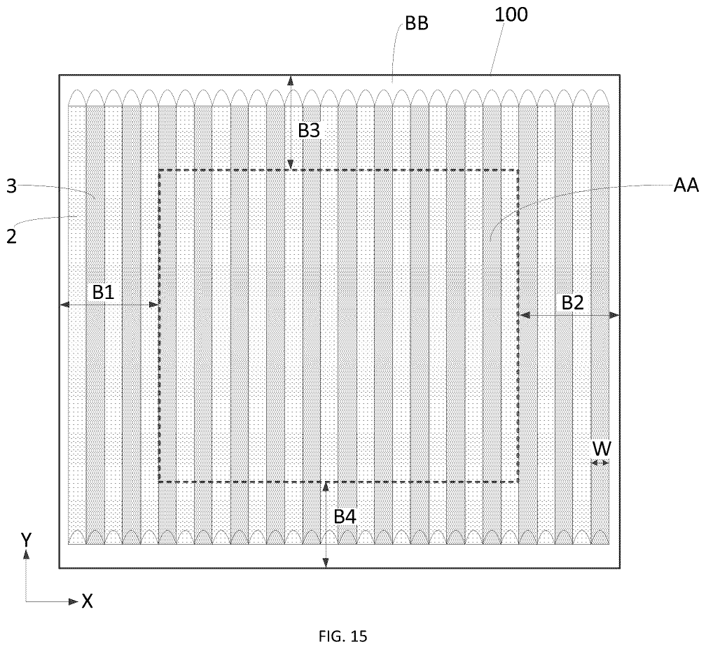

In specific implementation, in the above-mentioned display apparatus provided by the embodiments of the present disclosure, as shown in FIG. 15, the display panel 100 has a display region AA and a peripheral region BB arranged around the display region AA. The display region AA is provided with a plurality of pixel islands P, and the peripheral region BB includes: a first sub-region B1 and a second sub-region B2 arranged along the direction (i.e., the direction X) perpendicular to the extension direction of the first microlens 2, and a third sub-region B3 and a fourth sub-region B4 arranged along the extension direction (i.e., the direction Y) of the first microlens 2.

Along the direction perpendicular to the extension direction of the first microlens 2, the number of microlenses (the sum of the first microlenses and the second microlenses) arranged in the first sub-region B1 and the number of microlenses arranged in the second sub-region B2 each are greater than or equal to 5. In order to avoid the non-display region being too wide, it is advisable to set 5 to 10 microlenses, and FIG. 15 takes 5 microlenses as an example.

Preferably, along the direction (i.e., along the direction X) perpendicular to the extension direction of the first microlenses 2, taking a width of a first microlens 2 is a first width W1 as an example, the lengths of the first microlens 2 and the second microlens 3 that extend to the third sub-region B3 and the fourth sub-region B4 are greater than or equal to the width of the first sub-region B1 in which the number of microlenses is 5, so as to avoid light crosstalk at the edge(s) of the display region AA and improve the display effect. In order to avoid the non-display region being too wide, it is desirable to set the lengths of the first microlens 2 and the second microlens 3 that extend to the third sub-region B3 and the fourth sub-region B4 in the condition that the length of the first sub-region B1 in which the number of microlenses is in a range of 5 to 10. Preferably, B1=B2; and B3=B4. Further preferably, B1=B2=B3=B4.

Based on the same inventive concept, the embodiments of the present disclosure further provide a nanoimprint microlens template, including the above-mentioned microlens structure provided by the embodiments of the present disclosure. Specifically, the above-mentioned microlens structure shown in FIG. 1A and FIG. 1B provided by the embodiments of the present disclosure can be used as the nanoimprint microlens template, so that the template can be used to manufacture a tight connection microlens structure in other applications, such as the microlens structure is manufactured at the light emergent side of the display device. The microlens structure manufactured by the embodiments of the present disclosure is directly used as an embossed microlens template, and the tight connection microlens structure can be manufactured at one time, or the tight connection microlens structure can be manufactured by a transfer printing method, which can reduce the complexity of the process and the cost, and the manufactured display apparatus (such as a 3D display apparatus) prepared with the tight connection microlens structure has the better light effect, viewing angle and pixel resolution.

In the microlens structure, the manufacturing method therefor, and a related use thereof provided by the embodiments of the present disclosure, two kinds of microlenses (i.e., the first microlenses and the second microlenses) are arranged on the base substrate, and the first microlenses and the second microlenses may be manufactured respectively by two-time thermal reflow processes. For example, the plurality of first microlenses arranged at intervals are firstly manufactured on the base substrate by one-time thermal reflow process, and then the plurality of second microlenses are manufactured to be respectively located at the gaps of the first microlenses on the base substrate by another-time thermal reflow process, and the edges of the second microlenses manufactured by the second-time thermal reflow process overlap with the edges of the first microlenses manufactured by the first-time thermal reflow process, that is, the microlens structure in which the second microlenses are in tight connection with the first microlenses is manufactured using the staggered filling method. When the microlens structure provided by the embodiments of the present disclosure is applied to the light emergent side of the display device to realize 3D light field display, it is not necessary to manufacture the light-shielding layer located at the gaps between the microlenses to prevent light crosstalk. Therefore, the microlens structure provided by the embodiments of the present disclosure may omit the process of the alignment mark layer and the light-shielding layer, thereby reducing the complexity of the process and lowering the cost, and the omission of the light-shielding layer can improve the light efficiency and viewing angle of the display device, and can improve the pixel resolution of the display device.

While preferred embodiments of the present disclosure have been described, additional changes and modifications can be made to these embodiments by those skilled in the art once the basic inventive concept is appreciated. Therefore, it is intended that the appended claims be construed to cover the preferred embodiment and all changes and modifications which fall within the scope of the present disclosure.

Apparently, those skilled in the art can make various changes and modifications to the embodiments of the present disclosure without departing from the spirit and scope of the embodiments of the present disclosure. In this way, if the modifications and variations of the embodiments of the present disclosure fall within the scope of the claims of the present disclosure and their equivalents, the present their equivalents also intends to include these modifications and variations.

1. A microlens structure, comprising:
a base substrate;
a plurality of first microlenses located on the base substrate, wherein the plurality of first microlenses are arranged at intervals; and
a plurality of second microlenses located on the base substrate and respectively located at gaps between the plurality of first microlenses, respectively; wherein edges of at least part of the plurality of second microlenses overlap with edges of corresponding first microlenses.

2. The microlens structure according to claim 1, wherein edges of all the second microlenses overlap with edges of corresponding first microlenses.

3. The microlens structure according to claim 2, wherein an overlapping width of an edge of the second microlens with an edge of the first microlens is in a range of 0.5 μm to 2 μm.

4. The microlens structure according to claim 1, further comprising a plurality of transparent protection structures located between the plurality of first microlenses and the plurality of second microlenses and covering the plurality of first microlenses, wherein surface topographies of the plurality of transparent protection structures are the same as surface topographies of the plurality of second microlenses.

5. The microlens structure according to claim 4, wherein the plurality of transparent protection structures comprise silicon nitride, silicon oxide or silicon oxynitride.

6. The microlens structure according to claim 1, wherein a material of the plurality of first microlenses is the same as a material of the plurality of second microlenses.

7. The microlens structure according to claim 6, wherein the material of the plurality of first microlenses and the material of the plurality of second microlenses both comprise a resin.

8. The microlens structure according to claim 7, wherein the resin comprises at least one of a polyacrylic resin, a polyimide resin or a phenolic resin.

9. The microlens structure according to claim 1, wherein a difference between a caliber the first microlens and a caliber of the second microlens is in a range of 0 μm to 4 μm, and a difference between an arch height of the first microlens and an arch height of the second microlens is in a range of 0 μm to 3 μm.

10. The microlens structure according to claim 9, wherein the caliber of the first microlens and the caliber of the second microlens are both in a range of 10 μm to 300 μm, and the arch height of the first microlens and the arch height of the second microlens are both in a range of 5 μm to 30 μm.

11. The microlens structure according to claim 1, wherein surface precision of the plurality of first microlenses and surface precision of the plurality of second microlenses are both less than 10 nm, and roughness of the plurality of first microlenses and roughness of the plurality of second microlenses are both less than 1 nm.

12. A display apparatus, comprising: a display panel, and the microlens structure according to claim 1 located at a light emergent side of the display panel.

13. The display apparatus according to claim 12, wherein the base substrate of the microlens structure is a spacer layer, and the display apparatus further comprises a planarization layer located at a side of the microlens structure away from the base substrate, and a refractive index of the planarization layer is smaller than a refractive index of the microlens structure.

14. The display apparatus according to claim 12, wherein an alignment deviation between the microlens structure and the display panel is less than or equal to 5 μm.

15. The display apparatus according to claim 12, wherein the display panel comprises:
a driving backplane; and
a plurality of sub-pixels located between the driving backplane and the base substrate;
wherein the plurality of sub-pixels are divided into multiple pixel islands, each of the pixel islands comprises a plurality of sub-pixels, and sub-pixels in the same one pixel island display the same color; and
along a direction perpendicular to an extension direction of the plurality of first microlenses, one pixel island corresponds to at least one of the plurality of first microlenses or at least one of the plurality of second microlenses, and a number of sub-pixels included in each pixel island is greater than or equal to a sum of a quantity of the first microlenses and the second microlenses corresponding to the pixel island.

16. The display apparatus according to claim 14, wherein the display panel is provided with a display region and a peripheral region disposed around the display region; wherein the peripheral region comprises: a first sub-region and a second sub-region arranged along the direction perpendicular to the extension direction of the plurality of first microlenses, and a third sub-region and a fourth sub-region along the extension direction of the plurality of first microlenses;
wherein along the direction perpendicular to the extension direction of the plurality of first microlenses, a sum of a quantity of the first microlenses and the second microlenses arranged in the first sub-region and a sum of a quantity of the first microlenses and the second microlenses arranged in the second sub-region each are greater than or equal to 5.

17. A nanoimprint microlens template, comprising the microlens structure according to claim 1.

18. A method for manufacturing the microlens structure according to claim 1, comprising:
manufacturing the plurality of first microlenses arranged at intervals on the base substrate; and
manufacturing the plurality of second microlenses respectively located at the gaps between the plurality of first microlenses on the base substrate; wherein the edges of at least part of the plurality of second microlenses overlap with the edges of the corresponding first microlenses.

19. The method according to claim 18, wherein the manufacturing the plurality of first microlenses arranged at intervals on the base substrate specifically comprises:
forming a first photosensitive resin layer on the base substrate;
exposing and developing the first photosensitive resin layer to form a plurality of first transition patterns that are set independently; and
performing a first-time thermal reflow process on the plurality of first transition patterns to form the plurality of first microlenses.

20. The method according to claim 18, wherein the manufacturing plurality of second microlenses respectively located at the gaps between the plurality of first microlenses on the base substrate specifically comprises:
forming a second photosensitive resin layer on a side of the plurality of first microlenses away from the base substrate;
exposing and developing the second photosensitive resin layer to form a plurality of second transition patterns respectively located between the plurality of first microlenses; wherein edges of at least part of the plurality of second transition patterns overlap with edges of corresponding first microlenses; and
performing a second-time thermal reflow process on the plurality of second transition patterns to form the plurality of second microlenses; wherein the plurality of first microlenses and the plurality of second microlenses form the microlens structure.
